(19) United States
(12) Patent Application Publication
(10) Pub. No.: US 2025/0149276 A1
(43) Pub. Date: May 8, 2025

(54) SWITCHING DEVICE WITH AN ISOLATING OR EARTHING FUNCTION

(71) Applicant: Siemens Energy Global GmbH & Co. KG, München (DE)

(72) Inventors: Paul Gregor Nikolic, Erlangen (DE); Frank Reichert, Weissenfels (DE)

(21) Appl. No.: 18/725,903

(22) PCT Filed: Nov. 25, 2022
(86) PCT No.: PCT/EP2022/083238

§ 371 Date: Jul. 1, 2024

(30) Foreign Application Priority Data
Dec. 30, 2021 (DE) 10 2021 215 095.0

(51) Int. Cl. H01H 33/70; H01H 33/53

(52) U.S. Cl. CPC H01H 33/7023; H01H 33/53

(57) ABSTRACT

A switching device has an isolating or earthing function. The switching device contains an encapsulation housing filled with an insulating gas, a first contact arrangement with a first main contact and a first arc contact, a second contact arrangement with a second main contact and a second arc contact, and a nozzle arrangement which is configured to subject a switching arc between the arc contacts to an insulating gas flow. The contact arrangements are moveable relative to one another between a first end position and a second end position. During the movement from the first end position to the second end position, the main contacts are isolated from one another upstream of the arc contacts and a switching arc between the arc contacts is quenched by subjecting the switching arc to an insulating gas flow.

The invention relates to a switching device with a disconnecting or grounding function and an encapsulation housing filled with an insulating gas.

In conventional gas-insulated switchgear assemblies, sulfur hexafluoride is used for the most part as insulating gas. The dielectric strength of sulfur hexafluoride is sufficient to enable operationally reliable function of disconnecting and grounding switches arranged in switchgear assemblies of this type. However, sulfur hexafluoride is a strong greenhouse gas. Inter alia, sulfur hexafluoride is therefore increasingly being replaced by more environmentally acceptable insulating gases, particularly by synthetic air. Synthetic air here refers to a mixture made of oxygen and nitrogen, which is produced synthetically. In this case, it may be a completely synthetically produced mixture of oxygen and nitrogen or processed, particularly purified and/or dehumidified, air.

The use of synthetic air instead of sulfur hexafluoride in a gas-insulated switchgear assembly can endanger the operationally reliable function of conventional disconnecting and grounding switches, however, particularly in high-voltage switchgear assemblies. Owing to the generally relatively low switching speeds of these disconnecting and grounding switches and the lower dielectric strength of synthetic air compared to sulfur hexafluoride, relatively long switch arcs can form, namely during switch-off processes, between the switching contacts of the disconnecting and grounding switches, which switch arcs can additionally propagate in the housing of the switchgear assembly.

The invention is based on the object of specifying an improved switching device with a disconnecting or grounding function and an encapsulation housing filled with an insulating gas, particularly with synthetic air.

The object is achieved according to the invention using a switching device having the features of claim 1.

Advantageous embodiments of the invention are the subject matter of the dependent claims.

A switching device according to the invention with a disconnecting or grounding function comprises
an encapsulation housing filled with an insulating gas,
a first contact arrangement having a first main contact and a first arcing contact which is connected to the first main contact in an electrically conductive manner,
a second contact arrangement having a second main contact and a second arcing contact which is connected to the second main contact in an electrically conductive manner, and
a nozzle arrangement which is set up for streaming insulating gas onto a switch arc between the arcing contacts, wherein
the contact arrangements are movable relatively to one another between a first end position, in which the main contacts contact one another and the arcing contacts contact one another, and a second end position, in which the main contacts are disconnected from one another and the arcing contacts are disconnected from one another, wherein
during the movement from the first end position into the second end position, the main contacts upstream of the arcing contacts are disconnected from one another and a switch arc between the arcing contacts is quenched by streaming insulating gas onto the switch arc.

A switching device with a disconnecting function is also termed a disconnect switch or disconnector. A switching device of this type is used for disconnecting electrical circuits if no load current is flowing. Nonetheless, prior to the disconnection between contacts of the switching device, an electric current, particularly a reactive current, can flow. A switching device with grounding function is also termed a grounding switch or ground electrode and is used for grounding a current path. Furthermore, there are switching devices having a combined disconnecting and grounding function, which carry out grounding following the disconnection. The invention also relates to switching devices having combined disconnecting and grounding function.

A switching device according to the invention with a disconnecting or grounding function comprises an encapsulation housing filled with an insulating gas and is therefore realized in a gas-insulated manner. The switching device comprises contact arrangements which can be moved relatively to one another and which in each case have a main contact and an arcing contact which is connected to the main contact in an electrically conductive manner. To interrupt a current path, the contact arrangements are disconnected from one another, wherein initially the main contacts and subsequently the arcing contacts are disconnected from one another. A current that is flowing between the main contacts prior to the disconnection of the main contacts in this case commutates to the arcing contacts, so a switch arc can only be created between the arcing contacts. To quench a switch arc of this type, the switching device has a nozzle arrangement which is set up to stream insulating gas onto the switch arc and quench the switch arc as a result. Thus, the invention integrates a quenching principle, which is known from self-blast power circuit breakers, for quenching switch arcs in the contact system of a switching device with a disconnecting or grounding function. The invention enables the use of insulating gases with a lower dielectric strength than the dielectric strength of sulfur hexafluoride for example in a gas-insulated switching device with a disconnecting or grounding function.

In one embodiment of the invention, the insulating gas is synthetic air. In this case, the synthetic air is admitted in the encapsulation housing, preferably with an overpressure in the range of 6 to 14 bar with respect to a pressure in an environment of the encapsulation housing.

The previously mentioned embodiment of the invention is directed toward the use of synthetic air as insulating gas and therefore toward the use of a particularly environmentally acceptable insulating gas.

In a further embodiment of the invention, the arcing contacts are manufactured from tungsten-copper. Tungsten-copper designates an alloy made from tungsten and copper. Alloys of this type are advantageously suited as materials for arcing contacts owing to the high temperature resistance of tungsten and the high electrical and thermal conductivity of copper.

In a further embodiment of the invention, the first arcing contact is formed in a tube-like manner and the second arcing contact is formed in a pin-like manner.

Furthermore, the first arcing contact has an internal diameter that corresponds to an external diameter of the second arcing contact. This design of the arcing contacts allows the second arcing contact to be inserted into the first arcing contact, during which insertion the arcing contacts bear against one another and thus have a secure electrical and mechanical connection.

In a further embodiment of the invention, the first main contact is designed as a metallic sleeve, in which the first arcing contact is arranged. This advantageously allows passage of the insulating gas in and through the first main contact in order to quench a switch arc.

In a further embodiment of the invention, the nozzle arrangement has an insulating-material nozzle which is arranged on an inner surface of the first main contact and has a first nozzle section, which runs around an end region of the first arcing contact, and a second nozzle section, which faces the second arcing contact.

For example, the insulating-material nozzle is manufactured from a fluorine-free plastic, for example from polypropylene. By means of the insulating-material nozzle, it is possible in particular to delimit an arcing region in which a switch arc is burning between the arcing contacts, and guide the flow of insulating gas.

In a further embodiment of the invention, the nozzle arrangement has at least one blowout opening in the first main contact on a side of the first arcing contact facing away from the second arcing contact.

In an embodiment of the invention, which is alternative to the previously mentioned embodiment, the nozzle arrangement has a blowing chamber that is arranged inside the first main contact on a side of the first arcing contact facing away from the second arcing contact.

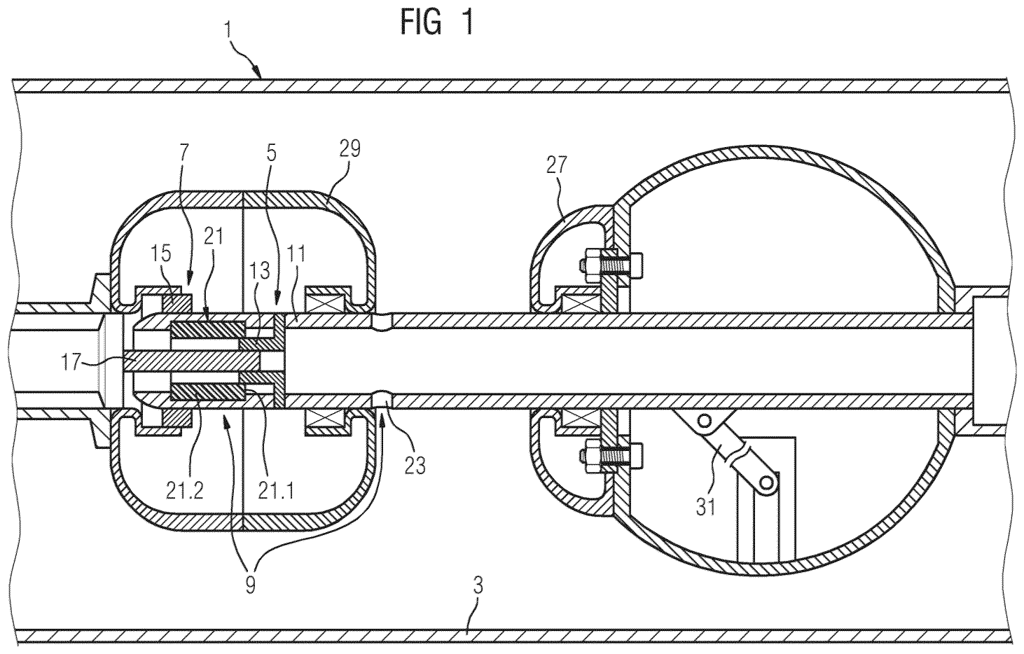

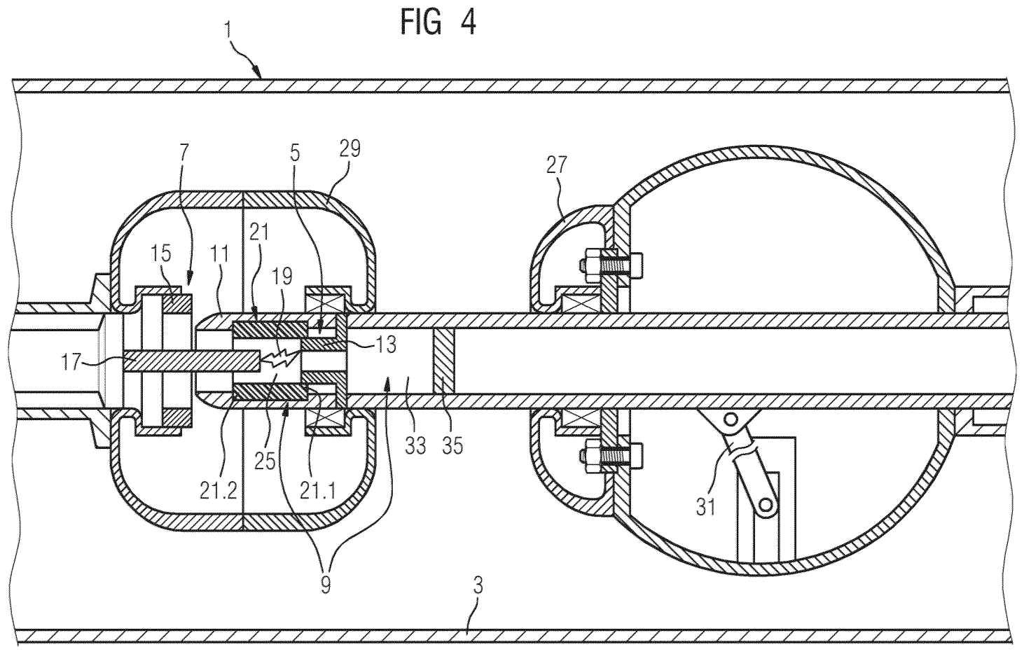

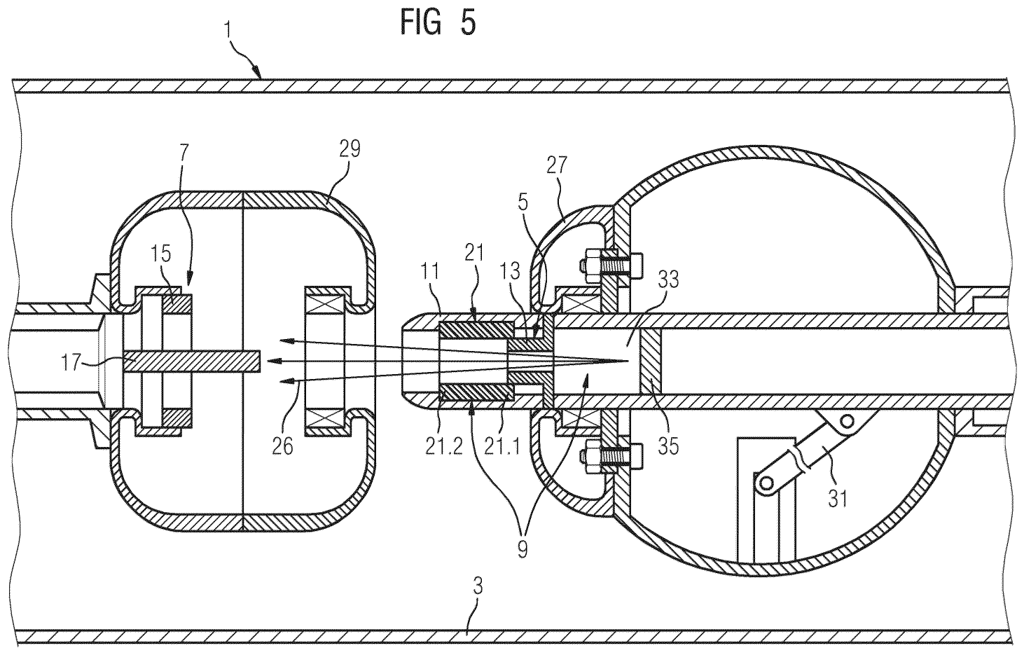

The two previously mentioned embodiments of the invention are advantageous in connection with the above-mentioned tube-like design of the first arcing contact and its arrangement in a first main contact, which is realized in a sleeve-like manner. In the first of the two previously mentioned embodiments of the invention, insulating gas that is heated by a switch arc flows out of the arcing region through the first arcing contact to the at least one blowout opening in the first main contact (see FIGS. 1 to 3 and the description thereof). In the second of the two previously mentioned embodiments of the invention, insulating gas that is heated by a switch arc flows out of the blowing chamber through the first arcing contact into the arcing region (see FIGS. 4 and 5 and the description thereof). In both cases, a switch arc that is burning in the arcing region can be quenched by the flow of the insulating gas.

In a further embodiment of the invention, the second main contact has elastic contact fingers for contacting the first main contact. This advantageously enables electrical and mechanical contact of the main contacts which is reliable and compensates manufacturing and motion tolerances.

The above-described properties, features and advantages of this invention and the manner in which these are achieved become clearer and more clearly understandable in connection with the following description of exemplary embodiments that are explained in more detail in connection with the drawings. In the figures:

FIG. 1 shows a sectional illustration of a first exemplary embodiment of a switching device in a first end position,

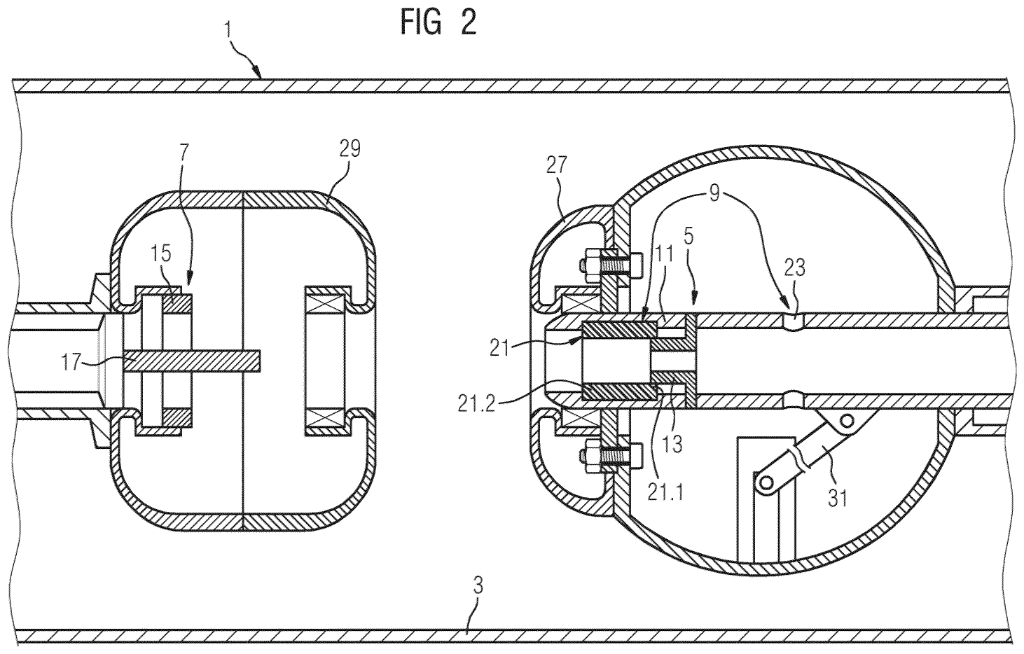

FIG. 2 shows a sectional illustration of the switching device shown in FIG. 1 in a second end position,

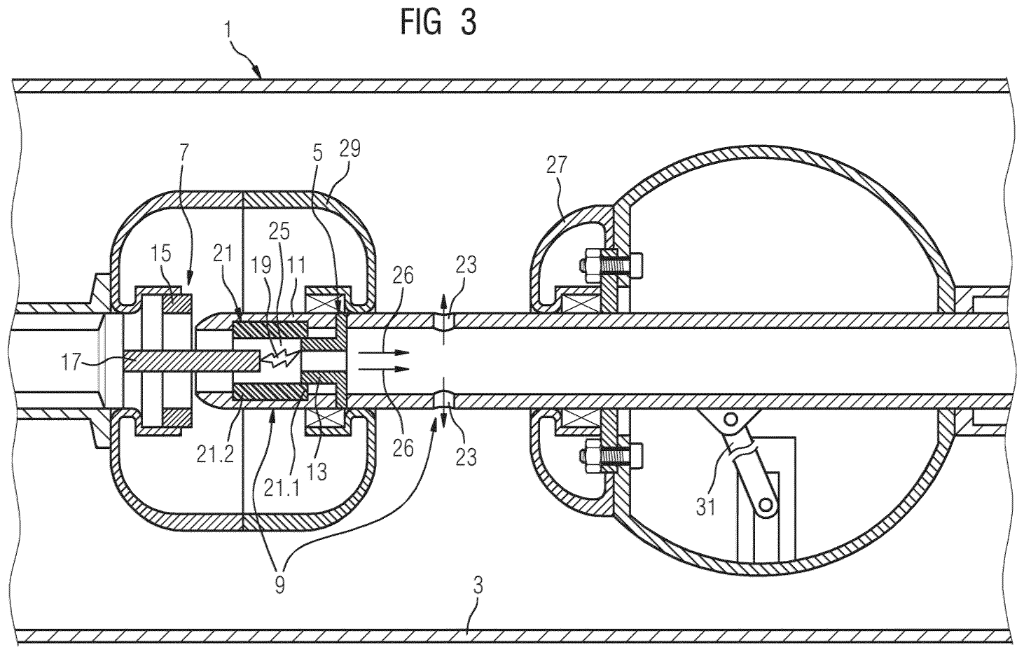

FIG. 3 shows a sectional illustration of the switching device shown in FIG. 1 in an intermediate position between the two end positions,

FIG. 4 shows a sectional illustration of a second exemplary embodiment of a switching device in a first intermediate position between the two end positions,

FIG. 5 shows a sectional illustration of the switching device shown in FIG. 4 in a second intermediate position between the two end positions.

Parts which correspond to one another are provided with the same reference signs in the figures.

FIGS. 1 to 3 show sectional illustrations of a first exemplary embodiment of a switching device 1 with a disconnecting or grounding function. The switching device 1 comprises an encapsulation housing 3, a first contact arrangement 5, a second contact arrangement 7 and a nozzle arrangement 9.

The encapsulation housing 3 is realized in a gas-tight manner and filled with synthetic air which is admitted with an overpressure in the range of 6 to 14 bar with respect to a pressure in an environment of the encapsulation housing 3.

The first contact arrangement 5 has a first main contact 11 and a first arcing contact 13 which is connected to the first main contact 11 in an electrically conductive manner.

The second contact arrangement 7 has a second main contact 15 and a second arcing contact 17 which is connected to the second main contact 15 in an electrically conductive manner. The first contact arrangement 5 is movable, relatively to the second contact arrangement 7 and the encapsulation housing 3, between a first end position and a second end position.

FIG. 1 (FIG. 1) shows the switching device 1 in the first end position of the first contact arrangement 5. In the first end position, the main contacts 11, 15 contact one another and the arcing contacts 13, 17 contact one another.

FIG. 2 (FIG. 2) shows the switching device 1 in the second end position of the first contact arrangement 5. In the second end position, the main contacts 11, 15 are disconnected from one another and the arcing contacts 13, 17 are disconnected from one another.

FIG. 3 (FIG. 3) shows the switching device 1 in an intermediate position of the first contact arrangement 5 during a movement from the first end position into the second end position. During this movement, the main contacts 11, 15 are initially disconnected from one another. As a result, an electric current flowing between the main contacts 11, 15 commutates to the arcing contacts 13, 17.

Subsequently, the arcing contacts 13, 17 are disconnected from one another. As a result, a switch arc 19 is created between the arcing contacts 13, 17.

The first arcing contact 13 is formed in a tube-like manner. The second arcing contact 17 is formed in a pin-like manner. The arcing contacts 13, 17 are manufactured from tungsten-copper in each case. The first arcing contact 13 has an internal diameter that corresponds to an external diameter of the second arcing contact 17. In the first end position of the first contact arrangement 5, an end region of the second arcing contact 17 protrudes into the first arcing contact 13. In this case, an outer surface of the end region of the second arcing contact 17 bears against an inner surface of the first arcing contact 13.

The first main contact 11 is formed as a metallic sleeve in which the first arcing contact 13 is arranged. The second main contact 15 has elastic contact fingers arranged in a lamellar manner, which bear against an outer surface of the first main contact 11 in the first end position of the first contact arrangement 5.

The nozzle arrangement 9 has an insulating-material nozzle 21 which is arranged on an inner surface of the first main contact 11. The insulating-material nozzle 21 has a first nozzle section 21.1, which runs around an end region of the first arcing contact 13, and a second nozzle section 21.2, which faces the second arcing contact 17. The insulating-material nozzle 21 is manufactured from a fluorine-free plastic, for example from polypropylene.

Furthermore, the nozzle arrangement 9 comprises a plurality of blowout openings 23 in the first main contact 11 on a side of the first arcing contact 13 facing away from the second arcing contact 17.

The nozzle arrangement 9 is set up to stream synthetic air onto the switch arc 19 between the arcing contacts 13, 17. Synthetic air is strongly heated by the switch arc 19 in an arcing region 25 which is surrounded by the insulating-material nozzle 21 and in which the switch arc 19 is burning, as a result of which the pressure in the arcing region 25 is increased. The synthetic air flows from the arcing region 25 through the tube-like first arcing contact 13 to the blowout openings 23 in the first main contact 11. This flow 26 of the synthetic air is indicated by arrows in FIG. 3 and quenches the switch arc 19.

Furthermore, a first electrode 27, a second electrode 29 and a lever element 31 are illustrated in FIGS. 1 to 3. The first electrode 27 surrounds the first contact arrangement 5 in its second end position and is open toward the second contact arrangement 7. The second electrode 29 is arranged in the region of the second contact arrangement 7 and open toward the first contact arrangement 5. The first contact arrangement 5 protrudes, in its first end position, into the second electrode 29. By means of the lever element 31, the first contact arrangement 5 can be moved for example by a motor (not illustrated). The first contact arrangement 5 is moved, during a movement between its end positions, for example approximately 50 mm to 300 mm, at a speed of less than 5 m/s.

FIGS. 4 and 5 show sectional illustrations of a second exemplary embodiment of a switching device 1 with a disconnecting or grounding function. This exemplary embodiment differs from the exemplary embodiment shown in FIGS. 1 to 3 essentially only due to the design of the nozzle arrangement 9.

The nozzle arrangement 9 in turn has an insulating-material nozzle 21 which is arranged on an inner surface of the first main contact 11. In contrast to the exemplary embodiment shown in FIGS. 1 to 3, the nozzle arrangement 9 further comprises a blowing chamber 33 instead of the blowout openings 23 in the first main contact 11 however, which blowing chamber is arranged inside the first main contact 11 on a side of the first arcing contact 13 facing away from the second arcing contact 17 and is delimited by a wall 35 arranged in the first main contact 11.

FIG. 4 (FIG. 4) shows the switching device 1 in a first intermediate position of the first contact arrangement 5 during the movement thereof from the first end position into the second end position. In the first intermediate position, a switch arc 19 burns between the arcing contacts 13, 17. The switch arc 19 heats synthetic air in the arcing region 25 and the blowing chamber 33, which is connected to the arcing region 25. This increases the pressure in the arcing region 25 and the blowing chamber 33. As the blowing chamber 33 is closed by the wall 35, synthetic air flows out of the blowing chamber 33 through the tube-like first arcing contact 13 into the arcing region 25 and quenches the switch arc 19.

FIG. 5 (FIG. 5) shows the switching device 1 in a second intermediate position of the first contact arrangement 5 during the movement thereof from the first end position into the second end position after the quenching of the switch arc 19.

The flow 26 of the synthetic air out of the blowing chamber 33 into the arcing region 25 is indicated by arrows in FIG. 5.

Although the invention was illustrated and described in more detail by preferred exemplary embodiments, the invention is not limited by the disclosed examples and other variations can be deduced from this by a person skilled in the art without departing from the protective scope of the invention.

1-11. (canceled)

12. A switching device with a disconnecting or grounding function, the switching device comprising:
an encapsulation housing filled with an insulating gas;
a first contact configuration having a first main contact and a first arcing contact connected to said first main contact in an electrically conductive manner;
a second contact configuration having a second main contact and a second arcing contact connected to said second main contact in an electrically conductive manner;
a nozzle configuration set up for streaming the insulating gas onto a switch arc between said first and second arcing contacts; and
said first and second contact configurations being movable relatively to one another between a first end position, in which said first and second main contacts contact one another and said first and second arcing contacts contact one another, and a second end position, in which said first and second main contacts are disconnected from one another and said first and second arcing contacts are disconnected from one another, wherein during a movement from the first end position into the second end position, said first and second main contacts upstream of said first and second arcing contacts are disconnected from one another and the switch arc between said first and second arcing contacts is quenched by streaming the insulating gas onto the switch arc.

13. The switching device according claim 12, wherein the insulating gas is synthetic air.

14. The switching device according claim 13, wherein the synthetic air is admitted in said encapsulation housing with an overpressure in a range of 6 to 14 bar with respect to a pressure in an environment of said encapsulation housing.

15. The switching device according to claim 12, wherein said first and second arcing contacts are manufactured from tungsten-copper.

16. The switching device according to claim 12, wherein said first arcing contact is formed in a tube-shaped manner and said second arcing contact is formed in a pin-shaped manner, and said first arcing contact has an internal diameter that corresponds to an external diameter of said second arcing contact.

17. The switching device according to claim 12, wherein said first main contact is configured as a metallic sleeve in which said first arcing contact is disposed.

18. The switching device according to claim 17, wherein said nozzle configuration has an insulating-material nozzle which is disposed on an inner surface of said first main contact and has a first nozzle section, which runs around an end region of said first arcing contact, and a second nozzle section, which faces said second arcing contact.

19. The switching device according to claim 18, wherein said insulating-material nozzle is manufactured from a fluorine-free plastic.

20. The switching device according to claim 17, wherein said nozzle configuration has at least one blowout opening formed in said first main contact on a side of said first arcing contact facing away from said second arcing contact.

21. The switching device according to claim 17, wherein said nozzle configuration has a blowing chamber that is disposed inside said first main contact on a side of said first arcing contact facing away from said second arcing contact.

22. The switching device according to claim 12, wherein said second main contact has elastic contact fingers for contacting said first main contact.

23. The switching device according to claim 19, wherein said fluorine-free plastic is polypropylene.
